(19) United States
(12) Patent Application Publication
(10) Pub. No.: US 2004/0045222 A1
(43) Pub. Date: Mar. 11, 2004

(54) Safety gate assembly

(76) Inventor: Robert James Hicks, Norfolk (GB)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/450,172

(22) PCT Filed: Dec. 11, 2001
(86) PCT No.: PCT/GB01/05464

(30) Foreign Application Priority Data
Dec. 14, 2000 (GB) 0030540.9

(51) Int. Cl. E05F 11/52

(52) U.S. Cl. 49/394; 49/50; 49/57; 49/157

(57) ABSTRACT

A safety gate assembly includes a generally U-shaped frame (3), which may be secured across a door opening, stairway or the like, and a gate (8), one side of which is connected by one or more pivotal connections (4, 7) to one side of the frame (3) to permit pivotal movement of the gate with respect to the frame about a pivotal axis and the other side of which carries a projecting latch member (9), which cooperates with a latch (1) connected to the other side of the frame. The latch (1) defines an entry (32) for the latch member and a locking position (36), in which pivotal movement of the gate (8) is prevented. The pivotal connections (4, 7) are constructed to permit linear movement of the gate relative to the frame (3) in the direction parallel to the pivotal axis. The entry (32) is connected to the locking position (36) by first and second paths (32, 44), the first path (42) including a one-way catch (40), which is constructed to permit the latch member (9) to move from the entry (32) to the locking position (36) along the first path (42) but to prevent the latch member (9) from moving along the first path (42) from the locking position (36) to the entry (32). The assembly also preferably includes means arranged to exert a pivotal force on the gate (8) to move it into the closed position in which the latch member (9) is in the locking position (36) within the latch (1).

The present invention relates to a childproof safety gate assembly, particularly of self-closing and self-latching type, which can be fitted across a doorway, stairway or the like. A childproof safety gate is one which may be readily opened by an adult but which a small child is incapable of opening. More specifically, the present invention relates to a safety gate assembly of the type including a generally U-shaped frame which may be secured across a door opening, stairway or the like, and a gate, one side of which is connected by one or more pivotal connections to one side of the frame to permit pivotal movement of the gate with respect to the frame about a pivotal axis and the other side of which carries a projecting latch member, which cooperates with a latch connected to the other side of the frame, the latch defining an entry for the latch member and a locking position, in which pivotal movement of the gate is prevented.

Safety gates are structures which are employed to prevent babies and young children from accessing certain areas at which they are to be denied access. They may also be used for controlling the movements of household pets. A safety gate may be fixed across a stairway or door opening to provide a secure barrier to prevent young children from falling downstairs or entering rooms in a home.

The disadvantage with known safety gates of this type is firstly that larger children tend to learn how to unlatch the gate and thus to gain access to areas to which they are supposed to have no access and secondly that the gate is sometimes accidentally left open by adults or older children in the family.

The object of the invention is therefore to provide a safety gate assembly which is childproof, that is to say which may not readily be opened by young children. A further object is to provide a safety gate assembly which closes and locks without the need for any action by the user, that is to say automatically.

According to the present invention, a safety gate assembly of the type referred to above is characterised in that the pivotal connections are constructed to permit linear movement of the gate relative to the frame in a direction parallel to the pivotal axis that the entry is connected to the locking position by first and second paths, that the first path includes a one-way catch, which is constructed to permit the latch member to move from the entry to the locking position along the first path but to prevent the latch member from moving along the first path from the locking position to the entry.

Thus the latch of the gate assembly in accordance with the present invention includes two paths extending between the entry portion and the locking position. One of these paths, that is to say the normal entry path, includes a one-way catch which readily permits movement of the latch member along it towards the locking position but prevents movement along it away from the locking position. This means that the gate may only be unlatched and then opened by moving the latch member along the second path and this will involve movement of the gate in the vertical direction and very probably also pivotal movement of the gate in one or both pivotal directions. Whilst an adult would be readily capable of effecting such complex movement of the gate, children will have inadequate strength or dexterity to do so, thereby rendering the gate childproof.

The one-way catch may take various forms but in one embodiment it comprises an elongate resilient member which partially defines the second path and extends into the first path and is constructed to deflect sufficiently to permit movement of the latch member along the first path into the locking position but not to deflect sufficiently to permit movement of the latch member along the first path out of the locking position.

It is preferred that the locking position is situated below the entry portion which will mean that the latch and latch member may be constructed to ensure that once the latch member is within the entry portion of the latch it will be guided automatically, e.g. by its own weight or by the application of an external force, e.g. by a spring, to move into the locking position.

It is preferred that the second path extends to a position higher than the first path which will mean that significant vertical movement of the gate will be necessary in order to unlatch it.

It is preferred also that the second path is so shaped that it is necessary to pivot the gate in one direction and then in the other direction to cause the latch member to move along it and in practice vertical movement of the gate will also be necessary before and/or after one or both of the pivotal movements of the gate.

As mentioned above, it is desirable for the gate to be of self-closing and preferably self-latching type and for this purpose it is preferred that the gate assembly includes means arranged to exert a pivoting force on the gate to move it into the closed position in which the latch member is in the locking position within the latch.

It is preferred that there are two pivotal connections. each of which includes a pivot pin, each pivot pin being rigidly connected to one of the gate and the frame and being rotatably and longitudinally slidably received in a bush connected to the other of the gate and the frame, and that one of the pivot pins, which is preferably but not necessarily the lower pivot pin, carries two opposed outwardly projecting pegs, the associated bush having two opposed slots formed in its side wall dimensioned to receive the pegs and, at one end, affords two part-helical inclined ramp surfaces against which the pegs are urged in the axial direction by the weight of the gate, when the gate is open, whereby the axial engagement force of the pegs with the ramp surfaces is converted by the engagement of the pegs with the inclined ramp surfaces into a moment which acts on the gate in the closing direction, the pegs and slots being so arranged that as the gate approaches the closed position they move into registry with one another and the gate is moved vertically downwards and the pegs move in the axial direction within the slots.

It is preferred that the means arranged to exert a pivotal force on the gate include a compression spring, which is arranged on one of the pivot pins and is arranged to exert a downward force on the gate.

Further features and details of the invention will be apparent from the following description of one specific embodiment of a safety gate assembly in accordance with the invention which is described by way of example with reference to the accompanying drawings, in which:

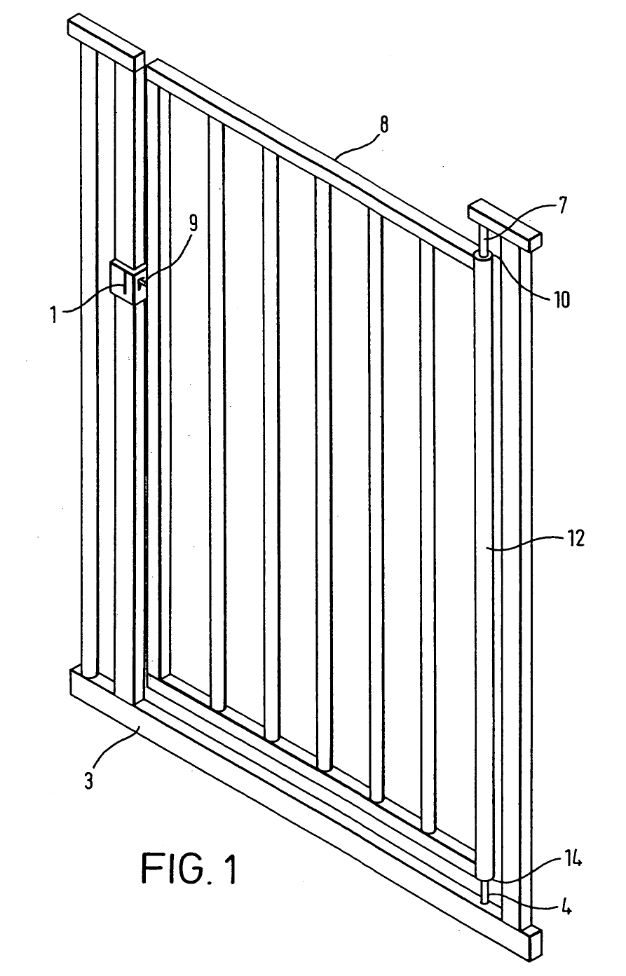

FIG. 1 is a perspective view of a self-closing, childproof safety gate assembly;

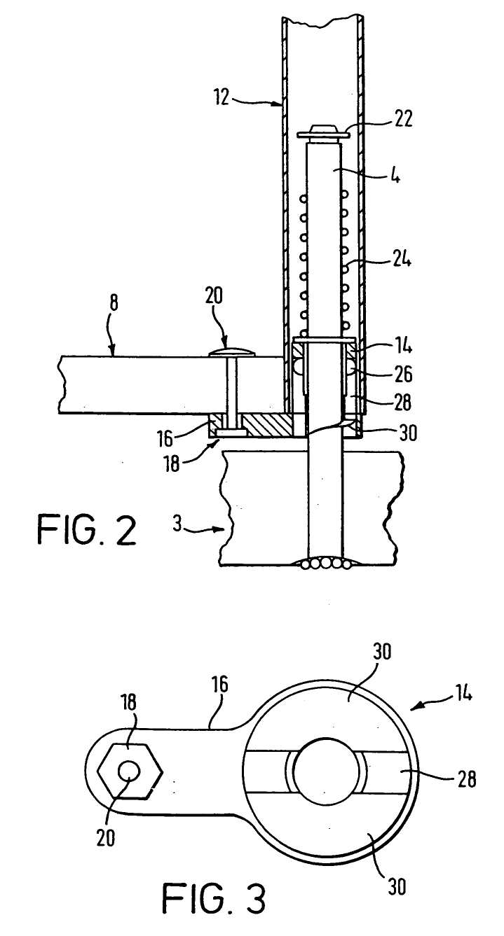

FIG. 2 is a scrap partly sectioned view of the lower pivotal connection of the gate to the frame;

FIG. 3 is an underneath view of the pivotal bush shown in FIG. 2; and

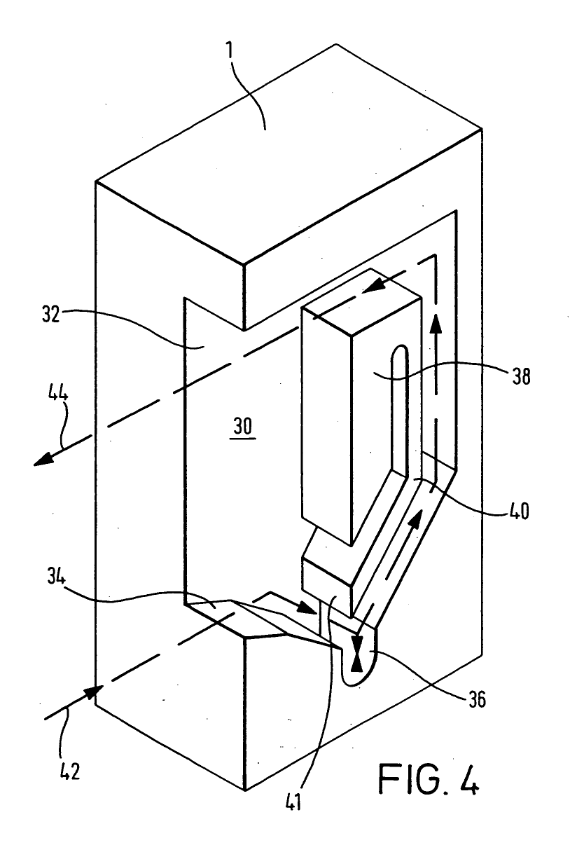

FIG. 4 is a perspective view of the latch block.

The illustrated gate assembly comprises an outer U-shaped frame 3, pivotally connected to one side of which by means of upper and lower hinge pins 7 and 4 is an inner gate 8. A locking or latch pin 9, which is securely fixed to and projects from the side of the gate remote from the hinge connections, engages into a latch block 1, which is attached to the frame 3. In practice, two spaced adjustable clamping mechanisms, which are not shown, would be connected to the outer surface of each outer limb of the frame 3. These are operated to releasably clamp the gate in a passage or doorway by moving them outwardly until they firmly engage the adjacent wall or portion of the door frame.

The upper hinge pin 7 is connected integrally to the frame 3 and extends downwardly from it. It is rotatably received in a circular section hole in a plastic bush 10, which is retained in a hole in the top of the hollow metallic tube 12 constituting the hinge side of the gate 8. The gate 8 may thus move vertically with respect to the frame 3 at the upper hinge pin 7.

The lower hinge pin 4 extends upwardly from the base of the frame 3 and is rotatably received in a circular section hole in a plastic bush 14 push-fitted in a hole in the bottom of the metallic tube 12. Integral with the foot of the bush 14 is an arm 16, which is connected to the underside of the gate 8 by a nut 18 and bolt 20. The hinge pin 4 extends through and beyond the bush 14 within the tube 12 and carries a washer 22 at its upper end. Extending around the hinge pin 4 and situated between the washer 22 and the bush 14 is a compression spring 24.

Extending from the hinge pin are two diametrically opposed pegs 26. The bush 14 has two diametrically opposed slots 28 formed in its side wall and on its underside it has two arcuate ramp surfaces 30 which ascend on the same sense.

When the gate is fully open, the spring 24 is compressed between the washer 22 and upper surface of the bush 14 and therefore urges the bush 14 and thus also the gate 8 downwardly. The pegs 26 engage respective ramp surfaces and the result of the helical inclined surfaces is to convert the downward forces of the spring and the weight of the gate into a torque which acts on the gate in the closing direction. As the gate moves into the closed position, the spring becomes fully relaxed and the pegs 26 then come into alignment with the slots 28 which are sized to receive them. Accordingly, the force exerted by the weight of the gate results in a sudden downward movement of the bush 14 as the pegs 26 move into and along the slots 28. The gate thus has two vertically spaced positions, an upper position, in which the pegs 26 are in engagement with the ramp surfaces 30, and a lower position, in which the pegs are accommodated within the slots 28.

The spring 24 is so dimensioned that when the gate is less than about one half open it is no longer compressed. However, the weight of the gate acting via the pegs 26 on the helical surfaces still exerts a closing force on the gate. Accordingly, it is primarily the weight of the gate which results in its closing and this effect is reinforced by the compression spring when the gate is more than about one half open.

The latch 1 comprises a rectangular section block, formed in the surface of which directed towards the gate 8 is an open recess 32. This recess is also open in the front surface of the latch block through an entry portion 32. The size and position of the entry portion 32 and of the latch pin 9 are such that the latch pin may enter through the lower portion of the entry portion when the gate 8 is in its upper position. The base of the entry portion 32 is constituted by a downwardly ramped surface 34, which communicates with a vertical sided latch slot 36, the width of which is only slightly greater than that of the latch pin 9 on the gate. Situated within the recess 30 and connected to the latch block is a formation 38, an elongate catch portion 40 of which is resilient and movable with respect to the block and whose end extends to a position above the slot 36 and close to the ramp surface 34 in which it is spaced from the ramp surface by a distance which is slightly less than the width of the latch pin 9. The free end surface 41 of the elongate portion 40 is inclined at an acute angle to its length and constitutes a ramp surface. The side surfaces of the formation 38 are spaced by small distance from the side surface of the recess 30 remote from the entry portion 32 and from the upper surface of the recess 30.

There are thus two pathways between the entry portion 32 and the latch slot 36. The first is designated 42 and extends from the lower portion of the entry portion 32, over the ramp surface 34 and into the slot 36. The second path is designated 44 and extends from the slot 36, through the gap defined between the formation 38 and the side and upper surfaces of the recess 30 and thence to the upper portion of the entry portion.

Accordingly, if the gate 8 is inadvertently left open, the action of the weight of the gate and perhaps also the force of the spring 34 pressing the pegs 26 against the ramp surfaces 30 exerts a closing torque on the gate and moves it in the closing direction. As the latch pin 9 approaches the latch block 1, its free end enters the recess 30 through the lower portion of the entry portion 32 along the path 42. Shortly after it has done so, the pegs 26 come into registry with the slots 28 in the bush 14 and the weight of the gate urges the gate and thus also the latch pin 9 downwardly. The latch pin 9 is thus pressed into contact with the downward ramp surface 34 and is caused to move downwardly along it until it contacts the ramped end of the resilient catch portion 40. The downward force exerted by the weight of the gate is sufficient to cause the latch pin 9 to deflect the catch portion 40 and the latch pin thus moves past the catch portion 40 and then downwardly into the latch slot 36. Further pivotal movement of the gate is now prevented by engagement of the latch pin with the side walls of the latch slot 36. If it is desired to open the gate, it is necessary firstly to unlatch it. This is effected by lifting the gate against the force of the spring 24. As the latch pin moves upwardly, it contacts the underside of the catch portion 40 and is incapable of deflecting it sufficiently to return to the entry portion 32 via the first pathway. It is instead deflected by the inclined underside of the catch portion 40 to follow the second pathway. The gate must therefore be lifted a substantial distance against the force of the spring 24 and the latch pin moves along the second pathway until it is in registry with the gap between the upper surfaces of the formation 38 and the recess 30. In this position the pegs 26 have moved out of the slots 28 and the gate is then pivoted in the opening direction so that the hinge pin 9 continues to move along the second pathway out of the entry portion 32 and the pegs 26 move to positions above the ramp surfaces 30. Whilst an adult is capable of exerting the necessary upward force and effecting the necessary relatively complex movements of the gate that are necessary to unlatch and open it, it is found that a young child is incapable of doing so and thus that the latch mechanism is “childproof”.

1. A safety gate assembly including a generally U-shaped frame (3), which may be secured across a door opening, stairway or the like, and a gate (8), one side of which is connected by one or more pivotal connections (4, 7) to one side of the frame (3) to permit pivotal movement of the gate with respect to the frame about a pivotal axis and the other side of which carries a projecting latch member (9), which cooperates with a latch (1) connected to the other side of the frame (3), the latch (1) defining an entry (32) for the latch member (9) and a locking position (36), in which pivotal movement of the gate (8) is prevented, characterised in that the pivotal connections (4, 7) are constructed to permit linear movement of the gate (8) relative to the frame (3) in a direction parallel to the pivotal axis, that the entry (32) is connected to the locking position (36) by first and second paths (42, 44), that the first path (42) includes a one-way catch (40), which is constructed to permit the latch member (9) to move from the entry (32) to the locking position (36) along the first path (42) but to prevent the latch member (9) from moving along the first path (42) from the locking position (36) to the entry (32).

2. An assembly as claimed in claim 1 in which the one-way catch comprises an elongate resilient member (40), which partially defines the second path (44) and extends into the first path (42) and is constructed to deflect sufficiently to permit movement of the latch member (9) along the first path (42) into the locking position (36) but not to deflect sufficiently to the movement of the latch member (9) along the first path (42) out of the locking position (36).

3. An assembly as claimed in claim 1 or 2, in which the locking position (36) is situated below the entry portion (32).

4. An assembly as claimed in any one of claims 1 to 3, in which the second path (44) extends to a position higher than the first path (42).

5. An assembly as claimed in any one of the preceding claims in which the second path (44) is so shaped that it is necessary to pivot the gate (8) in one direction and then in the other direction in order to cause the latch member (9) to move along it.

6. An assembly as claimed in any one of the preceding claims including means arranged to exert a pivotal force on the gate (8) to move it into the closed position in which the latch member (9) is in the locking position (36) within the latch (1).

7. An assembly as claimed in claim 6 in which there are two pivotal connections, each of which includes a pivot pin (4, 7), each pivot pin being rigidly connected to one of the gate (8) and the frame (3) and being rotatably and longitudinally slidably received in a bush (14, 10) connected to the other of the gate and the frame, and in which one of the pivot pins (4) carries two opposed outwardly projecting pegs (26), the associated bush (14) having two opposed slots (28) formed in its side wall dimensioned to receive the pegs and, at one end, affords two part-helical inclined ramp surfaces (30) against which the pegs (28) are urged in the axial direction by the weight of the gate, when the gate is open, whereby the axial engagement force of the pegs with the ramp surfaces is converted into a moment which acts on the gate (8) in the closing direction, the pegs (26) and slots (28) being so arranged that as the gate (8) approaches the closed position they move into registry with one another and the gate (8) is moved vertically downwards and the pegs (26) move in the axial direction within the slots (28).

8. Assembly as claimed in claim 6 or 7 in which the means arranged to exert a pivotal force on the gate include a compression spring (28), which is arranged on one of the pivot pins (4) and is arranged to exert a downward force on the gate.
